(19) United States
(12) Patent Application Publication
(10) Pub. No.: US 2025/0198207 A1
(43) Pub. Date: Jun. 19, 2025

(54) LOCK FOR A MOTOR VEHICLE

(71) Applicant: KIEKERT AG, Heiligenhaus (DE)

(72) Inventor: Uwe REDDMANN, Essen (DE)

(73) Assignee: KIEKERT AG, Heiligenhaus (DE)

(21) Appl. No.: 18/840,545

(22) PCT Filed: Feb. 13, 2023
(86) PCT No.: PCT/DE2023/100115

§ 371 Date: Aug. 22, 2024

(30) Foreign Application Priority Data
Mar. 9, 2022 (DE) 10 2022 105 517.5

(51) Int. Cl. E05B 85/02; E05B 77/34

(52) U.S. Cl. CPC E05B 85/02; E05B 77/34

(57) ABSTRACT

A lock for a motor vehicle, comprising a locking mechanism with a rotary catch and at least one locking pawl, wherein the rotary catch can be latched by means of the locking pawl in at least one latching position, a lock housing with at least one housing cover, a printed circuit board which is arranged in the interior of the lock housing, wherein the printed circuit board is arranged in a dry chamber which is separated at least from the locking mechanism, and wherein the dry chamber can be sealed by way of a plastics film.

The invention relates to a lock for a motor vehicle having a locking mechanism with a rotary catch and at least one locking pawl, wherein the rotary catch can be latched in at least one latching position by means of the locking pawl, a lock housing with at least one housing cover, a printed circuit board arranged in the interior of the lock housing, wherein the printed circuit board is arranged in a dry chamber separated at least from the locking mechanism.

Locks for motor vehicles are used where movable components arranged on the motor vehicle, such as doors, flaps, covers and/or sliding doors, need to be held or secured in their position. The primary task of the locks is to hold the movable component securely in position, even in an extreme situation, and thereby protect the operator or user of the motor vehicle from injuries. Such locks are also used in areas that are subject to environmental influences and can therefore come into contact with moisture, dust and/or other environmental influences.

The area of the locking mechanism in particular comes into contact with moisture or can even be directly affected by moisture. In addition to the pure security function of holding the movable component, the lock is increasingly given other tasks. In addition to purely mechanical holding the movable component, the lock can also contain electronics that are particularly susceptible to moisture. The electronics can, for example, serve to control a motor arranged in the motor vehicle lock and supply it with corresponding electrical power, or switching means can be contained in the vehicle lock, wherein by means of the switching means, for example, positions of functional components in the vehicle lock can be queried.

DE 10 2009 027 415 A1 discloses a lock for a motor vehicle which offers protection against external influences such as dust, moisture or tampering. A lock has a lock housing and a housing cover for the lock housing, wherein a circumferential slot remains between the lock housing and the cover, through which moisture can penetrate into the lock. In order to protect the components of the lock inside, it is proposed to wrap the lock at least partially several times with an adhesive film in order to thereby reliably and permanently protect the lock from external influences.

To protect the printed circuit board and/or other electronic components in the motor vehicle lock from penetrating moisture, the motor vehicle lock can be divided into a dry chamber and a wet area. Such a lock is known, for example, from EP 2 754 799 A1. The printed circuit board and the other electronic components are arranged moisture-tight between a cover cap and a lock cover.

In addition to the influence of direct moisture, the motor vehicle lock is also subject to strong temperature fluctuations. Vehicle locksmiths accordingly have to cover temperature ranges from −40° C. to +80° C. in order to function properly in all climate zones. However, temperature influences can have an effect on humidity and, particularly in the case of strong temperature fluctuations, moisture can escape from the air so that the electronic components can be affected by moisture.

DE 102 59 465 A1 discloses an actuator in which pressure differences occur in the interior of the actuator due to the movement of the actuating means. The actuator can also be arranged in the wet area of a motor vehicle, so that the internal components, as well as the actuating means, must be tightly sealed. In order to be able to equalize these pressure differences and at the same time prevent moisture from entering the interior of the actuator, it is proposed in the publication to provide a vent hole which is designed impermeable to moisture and at the same time permeable to air. For this purpose, a membrane is inserted into the vent hole, through which pressure equalization can take place, but which is also made of a semi-permeable plastic material that prevents the penetration of moisture.

Unpublished DE 10 2021 119 652.3 discloses a lock for a lock for a motor vehicle, having a locking mechanism with a rotary catch and at least one locking pawl, a lock housing with at least one housing cover, a printed circuit board arranged in an interior of the lock housing, wherein the printed circuit board is arranged in a dry chamber separated from the locking mechanism. By separating the printed circuit board, the electronics can be protected from moisture.

As already mentioned above, motor vehicle mechanics are subject to extreme temperature fluctuations or must at least guarantee consistently uniform functionality within the specified temperature ranges. It can also happen that large temperature jumps occur if, for example, a strongly heated motor vehicle is immediately and strongly cooled down. The strong temperature fluctuations can lead to negative pressures developing in the interior of the motor vehicle lock, by means of which moisture or wetness can enter and/or be drawn into the motor vehicle lock. Completely closing off a dry compartment in the motor vehicle lock can only be marginally ensured since a mechanism and/or electrical control lines or electrical components are connected to the locking mechanism and/or mechanisms for actuating the locking mechanism. This is where the invention comes into play.

The invention is based on the technical problem of further developing a motor vehicle lock of the type mentioned at the beginning in such a way that the electronic and/or electrical components and, in particular, a printed circuit board arranged in the motor vehicle lock can be protected from penetrating moisture.

According to the invention, the object is achieved by the features of independent claim 1. Advantageous embodiments are specified in the dependent claims. However, it should be noted that the embodiments described in the following are not limiting; rather, any possible variations of the features described in the description, the claims and the drawings are possible.

According to claim 1, the object of the invention is achieved in that a lock for a motor vehicle having a locking mechanism with a rotary catch and at least one locking pawl, wherein the rotary catch can be latched in at least one latching position by means of the locking pawl, a lock housing with at least one housing cover, a printed circuit board arranged in the interior of the lock housing, wherein the printed circuit board is arranged in a dry chamber separated at least from the locking mechanism, and wherein the drying chamber can be sealed with a flexible sealing element, in particular a plastic film. By using a plastic film to seal the drying chamber, temperature differences can be dealt with in an advantageous manner. If the plastic film covers the conductor track and/or electrical components, the plastic film can accordingly equalize pressure differences due to its flexibility. This can prevent moisture from penetrating into the region of the electronic or electrical components due to negative pressure. The sealing element or the plastic film covers the electrical and electronic components and is firmly connected to the lock housing all the way around. Pressure differences in the lock housing can be equalized by flexibly adjusting the sealing element or plastic film.

When a lock for a motor vehicle is addressed within the scope of the invention, this includes all locking systems which are used to hold a movable component in the motor vehicle. These locking systems have a locking mechanism with a rotary catch and at least one locking pawl, wherein the rotary catch can be brought into engagement with a lock holder, and the locking pawl can hold the rotary catch in at least one latching position.

Such a lock can be used, for example, in a side door, a flap, hood and/or sliding door, to name just a few examples of the use of the motor vehicle lock according to the invention.

If the motor vehicle lock is used in a side door, for example, two latching positions are specified in the locking mechanism. When closing the side door, the locking mechanism first moves to a prelatching position and then to a main latching position to close it completely. The rotary catch can be secured in the latching position by means of a locking pawl, or a locking pawl and a blocking or latching lever, depending on whether a closing or opening moment occurs in the locking mechanism. The locking mechanism is mounted in the motor vehicle lock on a metal lock case and can also be secured in the axle mounts by means of a reinforcement plate.

In order to protect the locking mechanism and the other functional components contained in the motor vehicle lock from dirt and/or moisture and to provide mounting or bearing points for the functional components of the lock, the lock has a lock housing with at least one housing cover. In addition to the housing cover, a cover cap can be located in the lock, particularly in the case in which there are weather-sensitive components in the motor vehicle lock. This cover cap then has the task of forming a wet region and a dry region in the motor vehicle lock. This makes it possible to arrange the wetness or moisture-sensitive components separately in the motor vehicle lock and provide additional security in the motor vehicle lock. Such moisture-sensitive components are, for example, electronic components, a printed circuit board or an electric motor. These components arranged in the interior of the lock housing are particularly moisture-sensitive since the ingress of moisture can impair the functionality of these components.

According to the invention, the printed circuit board is arranged in a dry chamber at least separated from the locking mechanism. The dry chamber is characterized by the fact that at least no direct moisture can penetrate into the drying chamber. The dry chamber can be formed by the lock housing in conjunction with the housing cover and a shape of the lock housing and/or a cover cap as an intermediate layer. The printed circuit board and/or other electrical components are therefore arranged in an isolated and/or sealed dry chamber or dry region of the motor vehicle lock and are connected there via an electrical component carrier and/or a connector plug and/or control lines to, for example, a control unit of the motor vehicle lock. By arranging the electrical components in the dry chamber, the printed circuit board and/or the electronic components can be protected at least directly from penetrating moisture.

However, the high temperature fluctuations between −40° C. and +80° C. that occur in the motor vehicle lock mean that humidity can escape from the air, strong pressure differences can occur within the different temperature ranges, so that moisture diffusion and/or penetration of seals by moisture can occur, so that moisture could in turn enter into the region of the electronic components. The use of the sealing element or the plastic film according to the invention prevents the different pressures resulting from the temperature differences from causing moisture to penetrate into the dry chamber. The elastic sealing element can equalize the pressure differences and therefore prevent air and/or moisture from being drawn into the dry chamber due to air pressure.

When referring to a sealing element within the scope of the invention, this primarily means a plastic film. However, alternative sealing elements are also conceivable, such as a metal foil or a component formed from a rubber-elastic plastic. In any case, the sealing element is able to flexibly or elastically equalize a pressure difference.

In an advantageous design variant, the plastic film can be connected at least partially to a contact surface of the housing cover. The plastic film can be arranged as a waterproof and pressure-equalizing film between the printed circuit board and the housing cover of the lock housing. This makes it possible to enable a seal in the direction of the housing cover. The housing cover and lock housing are usually connected by means of circumferential seals and screwed or clipped together. This type of seal cannot guarantee an absolute seal in all cases. To be mentioned here are manufacturing and installation reasons as well as environmental influences. By using and attaching the plastic film to the contact surface of the housing cover, the plastic film can guarantee a seal in the region of the electronic components and in particular the printed circuit board. The plastic film can be arranged as far in the region of the contact surface of the housing cover at least as the housing cover encloses the electronic components.

It can also be advantageous if the plastic film is arranged at least partially between the housing cover and the lock housing. Depending on the structural design of the lock housing, the printed circuit board or the at least one electronic component can be arranged between the housing cover and the lock housing and/or a cover cap. Depending on the embodiment, an intermediate region between the housing cover and the lock housing and/or the housing cover and the cover cap thus forms the dry region provided for the electrical components. If the plastic film is now arranged between these components of the lock housing, the dry chamber can provide additional protection against moisture penetrating into the dry chamber. In this case, the plastic film can also be partially arranged on the housing cover, lock housing and/or a cover cap.

In an advantageous manner, the plastic film can be firmly, in particular inseparably, connected to the lock housing and/or a cover cap in such a way that a dry chamber formed by the lock housing and/or the cover cap and the plastic film can be formed. The dry chamber is additionally sealed by the plastic film and prevents moisture and/or wetness from penetrating into the dry chamber.

Of course, the plastic film also protects against dusts or other contaminants that can occur in the lock such as greases or oils, although at least dusts cannot exert such a harmful effect on the functionality of the electronic components. The plastic film is inseparably connected to the housing or housing components. For example, a laser beam method can be used for this. Of course, similar method that enable material bonding can also be used. A laser beam method offers the advantage of good automatability in series production. However, it is also conceivable that, for example, an integral connection, such as gluing, is used to inseparably connect the plastic film to the lock housing. The plastic film can therefore be connected to the lock housing by the inseparable connection and at the same time be fixed to the lock housing by another housing part.

In an advantageous way, the plastic film can be elastic. The plastic film can adapt to the ambient conditions due to its flexibility or elasticity. For example, if there is significant heating of the motor vehicle, for example due to solar radiation, the air inside the motor vehicle lock expands. The expansion of the air can be elastically absorbed by the plastic film. If there is significant cooling of the motor vehicle and the air contracts, the change in volume can be absorbed by the elasticity of the plastic film. In particular, pressure differences can thereby be equalized, which can prevent the diffusion of moist air, for example.

In an advantageous way, the plastic film can also be corrugated. Due to an at least partial formation of the plastic film in a corrugated shape, the plastic film can be provided with additionally higher flexibility above the printed circuit board. This also reduces the risk of cracking if the plastic film is stretched by temperature differences. The plastic film therefore prevents pressure differences in the dry chamber, and in particular negative pressures in the dry chamber, from allowing or supporting the penetration of moisture.

If an opening is arranged in the lock housing and/or in the housing cover and/or in the cover cap, another advantageous embodiment of the invention can be achieved. Penetrating moisture can escape through openings in the lock. In particular, however, temperature equalization can take place through an opening in the lock so that temperature equalization can take place within a corresponding time even during operation under extreme loads, such as extreme heat or extreme cold. The plastic film protects the dry chamber and the electronic and/or electrical components. In an advantageous way, the housing opening can be closed by means of a membrane, in particular by means of a semipermeable membrane. This makes it possible to form an installation space above the electronic components, for example, wherein the installation space above the plastic film can be closed by a housing cover. Accordingly, for example, there is a housing shell into which electronic components are inserted and the electronic components are covered with the plastic film.

Above the plastic film there is then an installation space which is closed by means of the housing cover, and wherein a semi-permeable membrane is arranged in the housing cover. Pressure equalization can take place through the semipermeable membrane and thereby equalize the installation space with regard to temperature fluctuations with regard to the volume. The temperature and pressure-related changes in the installation space above the plastic film can be equalized through the membrane, wherein the plastic film adapts elastically and/or deforms to the pressure differences or temperature differences. In an advantageous way, the volume of the dry chamber below the film is always larger than a volume between the plastic film and the housing cover. The housing cover encloses or covers the plastic film in such a way that protection is provided for the plastic film. The installation space above the plastic film is used for pressure equalization, wherein the housing cover offers a protective function for the plastic film.

Under normal operating conditions, the plastic film glued and/or attached by means of a remelting method is sufficient to protect the electrical system or electronics from penetrating water, and/or moisture, and/or lubricants. However, should the case arise that the motor vehicle is immersed in water, the water pressure acts against the air volume in the installation space and water can penetrate into the motor vehicle lock. To counteract this circumstance, the plastic film can adapt elastically or flexibly to changes in pressure. The air in the installation space or dry chamber, which may cool down due to the water, can cause an additional suction effect. The plastic film has the task of providing an equalizing volume, that equalizes the water penetrating into the motor vehicle lock due to the increased water pressure and keeps the moisture away from the electronics. Thanks to the design according to the invention and the use of the plastic film, the function of the electrical system and electronics is also guaranteed in a submerged vehicle, and the functions to be provided electrically in the motor vehicle lock, such as door opening, can continue to be ensured.

The safety and, in particular, the durability of the motor vehicle lock can be ensured by the design of the motor vehicle lock according to the invention.

In the following, the invention is explained in more detail with reference to the accompanying drawings by means of an example of an embodiment. However, the principle applies that the exemplary embodiment does not limit the invention, but merely represents an advantageous embodiment. The shown features can be implemented individually or also in combination with other features of the description as well as the claims.

In the figures:

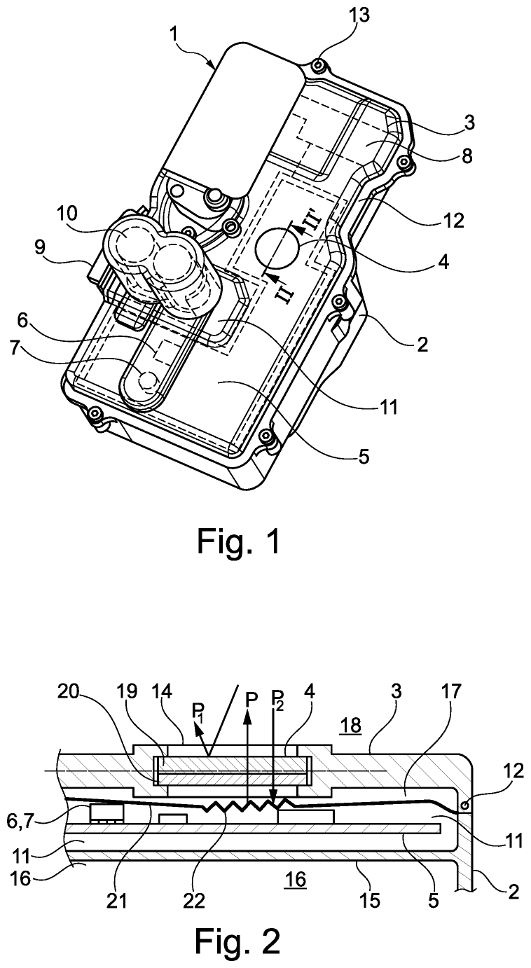

FIG. 1 shows a three-dimensional view of a motor vehicle lock designed according to the invention with a membrane in the housing cover, and

FIG. 2 shows a section along line II-II as shown in FIG. 1 through the motor vehicle lock as shown in FIG. 1.

FIG. 1 shows a three-dimensional view of a motor vehicle lock 1. It can be seen that the lock housing 2 and a housing cover 3 mounted on the lock housing. A membrane 4 is arranged in the housing cover 3 to equalize the pressure in the motor vehicle lock 1.

In FIG. 1, the housing cover 3 is shown transparent, so that the printed circuit board 5 arranged underneath the housing cover 3 can be seen. Electronic components 6, 7 are attached to the printed circuit board 5 and an electric motor 8 is electrically connected to the printed circuit board 5. Overall, the electrical system and electronics 5, 6, 7, 8 in the motor vehicle lock 1 are connected to the on-board electronics of the motor vehicle via a connector 9 on the housing 2. Additional capacitive components 10 are also arranged under the housing cover 3. Below the housing cover 3 there is a dry chamber 11 in which the printed circuit board and the electronic or electrical components 5, 6, 7, 8, 10 are arranged. Above the printed circuit board 5, the membrane 4 is arranged in the housing cover 3 so that the motor vehicle lock 1 can be vented via the membrane 4 and thereby dehumidified.

In principle, a seal is arranged around the edge 12 of the motor vehicle lock 1, and the housing cover is attached to the lock housing 2 by means of screws 13.

FIG. 2 shows a section through the motor vehicle lock 1 in the region of the membrane 4 along line II-II from FIG. 1. The membrane 4 is held in an opening of the housing cover 3 and arranged above the printed circuit board. The printed circuit board 5 is arranged in the dry region 11 of the motor vehicle lock 1. The dry region 11 can be delimited by a cover cap 15 so that the dry region 11 can be separated from the wet region 16 by means of the cover cap 15.

The membrane 4 is accommodated in an opening 14 of the lock housing cover 3 and is held in a sealing manner. If temperature fluctuations and/or leaks cause the air in an interior 17 to heat up, the pressure can be equalized through the membrane 4 in the direction of the arrow P. For this purpose, the membrane 4 is permeable to air in the direction of the arrow P, but impermeable to moisture. Moisture hitting the membrane 4, which is symbolized by the arrow P1, is pushed back by the membrane 4 or not allowed to pass through so that no moisture can penetrate through the membrane. However, an air exchange between the interior 17 of the lock 1 can pass outside into the environment 18. Moisture occurring in the interior 17 of the motor vehicle lock 1 can thereby be equalized through the membrane 4 within the context of air circulation through the membrane 4. For this purpose, the membrane 4 is permeable to air in the direction of the arrow P2.

The membrane 4 itself has a two-layer structure, with a semi-permeable plastic layer 19 arranged on the upper side, i.e., on the environment side 18, wherein the plastic layer 19 is supported and held on a carrier material 20.

The design of the motor vehicle lock according to the invention with a membrane for pressure equalization can advantageously prevent the formation of condensation in the interior 17 and in particular in a dry chamber 11. In particular, this improves the durability of electronic locks.

In FIG. 2, the plastic film 21 is drawn above the printed circuit board 5. The plastic film 21 separates the dry chamber 21 from the interior 17 which defines an installation space between the plastic film 21 and the housing cover 3. The plastic film 21 is arranged between the housing cover 3 and the lock housing 2 and can, for example, be fusion-welded to the lock housing 2 all the way around. The plastic film 21 completely insulates the dry chamber from the interior 17. Pressure differences between the interior 17 and the environment 18 can be equalized by the plastic film 21. Likewise, pressure differences between the interior 17 and the dry chamber 11 can be equalized by the plastic film 21. At the same time, a corrugation 22 can be seen in the plastic film 21, which also increases the elasticity or deformability of the plastic film 21. The printed circuit board 5 and the other electronic or electrical components 6, 7, 8 can thereby be efficiently protected against environmental influences and/or pollutants and can function reliably and for a long time even under extreme conditions.

### LIST OF REFERENCE SIGNS

1 Motor vehicle lock
2 Lock housing
3 Housing cover
4 Membrane
5 Printed circuit board
6, 7 Electronic components
8 Electric motor
9 Connector
10 Capacitive components
11 Dry chamber
12 Edge
13 Screws
14 Opening
15 Cover cap
16 Wet region
17 Interior
18 Environment
19 Plastic material
20 Carrier material
21 Plastic film
22 Corrugation
P, P1, P2 Arrow

1. A motor vehicle lock for a motor vehicle, the motor vehicle lock comprising:
a locking mechanism with a rotary catch and at least one locking pawl, wherein the rotary catch is latched in at least one latching position by the locking pawl,
a lock housing including a dry chamber in an interior of the locking housing and having at least one housing cover, and
a printed circuit board arranged in an interior of the dry chamber separated at least from the locking mechanism, wherein the dry chamber is sealed with a plastic film.

2. The motor vehicle lock according to claim 1, wherein the plastic film is connected at least partially to a contact surface comprising an edge, of the lock housing.

3. The motor vehicle lock according to claim 1, wherein the plastic film is arranged at least partially between the housing cover and the lock housing.

4. The motor vehicle lock according to claim 1, wherein the plastic film is inseparably connected to the lock housing and/or the housing cover in such a way that the dry chamber is defined by the lock housing and the plastic film.

5. The motor vehicle lock according to claim 1, wherein the plastic film is elastic.

6. The motor vehicle lock according to claim 1, wherein the plastic film is at least partially corrugated.

7. The motor vehicle lock according to claim 1, further comprising a housing opening arranged in the lock housing and/or in the housing cover.

8. The motor vehicle lock according to claim 17, wherein the housing opening is closed by a membrane.

9. The motor vehicle lock according to claim 1, wherein a volume of the dry chamber is greater than a volume between the plastic film and the housing cover.

10. The motor vehicle lock according to claim 1, wherein the plastic film is connected to the lock housing and/or the housing cover by a forming process and/or integrally.

11. The motor vehicle lock according to claim 8, wherein the membrane is a semi-permeable membrane that permits passage of air through membrane and prevents passage of water through the membrane.

12. The motor vehicle lock according to claim 11, wherein an installation space is defined between the housing cover and the plastic film, and the semi-permeable membrane is arranged in the housing cover.

13. The motor vehicle lock according to claim 8, wherein the membrane has a two-layer structure including a semi-permeable plastic layer arranged on an environment side, supported by a carrier material.

14. The motor vehicle lock according to claim 1, further comprising a cover cap that defines the dry area and separates the dry area from a wet area that contains the locking mechanism.
